(19) United States
(12) Patent Application Publication
(10) Pub. No.: US 2015/0185975 A1
(43) Pub. Date: Jul. 2, 2015

(54) INFORMATION PROCESSING DEVICE, INFORMATION PROCESSING METHOD, AND RECORDING MEDIUM

(71) Applicant: FUJI XEROX CO., LTD, Tokyo (JP)

(72) Inventors: Yoshio HASEGAWA, Kanagawa (JP); Daisuke YASUOKA, Kanagawa (JP); Miaki SUGIYAMA, Kanagawa (JP); Ritsuko AKAO, Kanagawa (JP); Yuki SHIMIZU, Kanagawa (JP)

(73) Assignee: FUJI XEROX CO., LTD, Tokyo (JP)

(21) Appl. No.: 14/330,708

(22) Filed: Jul. 14, 2014

(30) Foreign Application Priority Data
Dec. 27, 2013 (JP) 2013-271446

(51) Int. Cl. G06F 3/0482; G06F 3/0486

(52) U.S. Cl. CPC G06F 3/0482; G06F 3/0486

(57) ABSTRACT

An information processing device includes a position acquisition unit and an adding unit. The position acquisition unit acquires a first position and a second position specified on an image of a screen by a user. The adding unit is configured so that, in a case in which the user is in the middle of continuously specifying the first position for a set of a plurality of data selected by the user, and a position associated with other data besides the data set is acquired as a second position, the adding unit adds the other data to the data set.

### CROSS-REFERENCE TO RELATED APPLICATIONS

This application is based on and claims priority under 35 USC 119 from Japanese Patent Application No. 2013-271446 filed Dec. 27, 2013.

### BACKGROUND

The present invention relates to an information processing device, an information processing method, and a recording medium.

### SUMMARY

According to an aspect of the invention, there is provided an information processing device that includes a position acquisition unit and an adding unit. The position acquisition unit acquires a first position and a second position specified on an image of a screen by a user. The adding unit is configured so that, in a case in which the user is in the middle of continuously specifying the first position for a set of a plurality of data selected by the user, and a position associated with other data besides the data set is acquired as a second position, the adding unit adds the other data to the data set.

### BRIEF DESCRIPTION OF THE DRAWINGS

An exemplary embodiment of the present invention will be described in detail based on the following figures, wherein:

FIG. 1 is a diagram illustrating a hardware configuration of an information processing device according to an exemplary embodiment of the present invention;

FIG. 2 is an exterior view of an information processing device;

FIG. 3 is a diagram illustrating an example of a screen displayed on a touchscreen;

FIG. 4 is a diagram illustrating an example of a screen displayed on a touchscreen;

FIG. 5 is a diagram illustrating the state of a touchscreen when a drag operation is performed;

FIG. 6 is a diagram illustrating the state of a user touching an icon image of other data with a second finger;

FIG. 7 is a diagram illustrating the state of the second finger moving;

FIG. 8 is a diagram illustrating the state when the contact between the second finger and the touchscreen is disengaged near a bundle image;

FIG. 9 is a diagram illustrating the state of a user tapping an icon image with a second finger;

FIG. 10 is a diagram illustrating a tapped icon image returning to an original state;

FIG. 11 is a diagram illustrating the state of a user tapping near a bundle image with a second finger;

FIG. 12 is a diagram illustrating a guide image;

FIG. 13 is a diagram illustrating the state of a user moving a second finger from near a bundle image;

FIG. 14 is a flowchart illustrating a process executed by a controller;

FIG. 15 is a flowchart illustrating a process executed by a controller;

FIG. 16 is a flowchart illustrating a process executed by a controller;

FIG. 17 is a flowchart illustrating a process executed by a controller;

FIG. 18 is a flowchart illustrating a process executed by a controller; and

FIG. 19 is a diagram illustrating an example of a list displayed on a screen.

### DETAILED DESCRIPTION

Hereinafter, an exemplary embodiment of the present invention will be described in detail on the basis of the drawings.

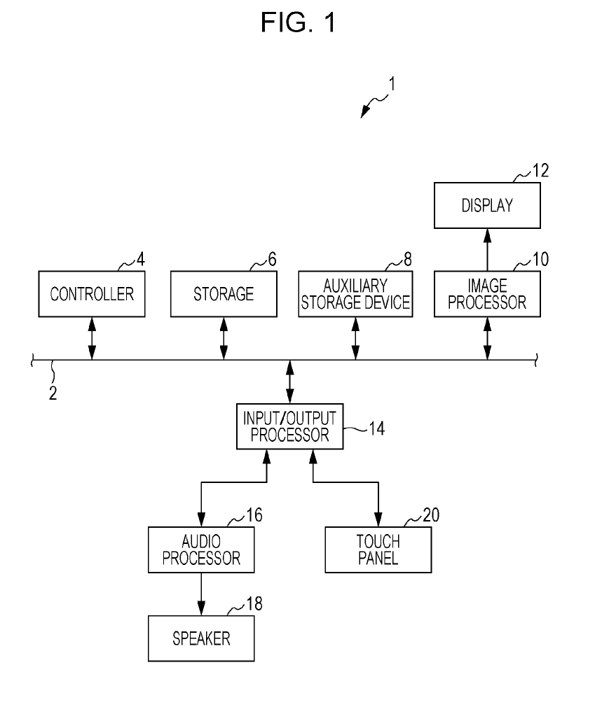

FIG. 1 illustrates a hardware configuration of an information processing device 1 according to an exemplary embodiment of the present invention. The information processing device 1 is realized as a tablet personal computer or mobile device (for example, a smartphone) equipped with a touchscreen, and as illustrated in FIG. 1, includes a bus 2, a controller 4, storage 6, an auxiliary storage device 8, an image processor 10, a display 12, an input/output processor 14, an audio processor 16, a speaker 18, a touch panel 20, and the like.

The bus 2 exchanges addresses and data with the respective components of the information processing device 1. The controller 4, storage 6, auxiliary storage device 8, image processor 10, and input/output processor 14 are connected to each other via the bus 2 to allow data communication.

The controller 4 is a microprocessor, and controls the respective components of the information processing device 1 on the basis of an operating system and an application program stored in the auxiliary storage device 8. The storage 6 includes RAM, for example, into which the application program is written as appropriate. The storage 6 is also used as a work area of the controller 4. Herein, the auxiliary storage device 8 is used in order to supply an application program, but any other computer-readable information storage medium, such as a CD-ROM or DVD, may also be used. In addition, an application program may also be supplied to the information processing device 1 from a remote location via a communication network such as the Internet.

The auxiliary storage device 8 is flash memory, for example, and stores an operating system and the above application program. The auxiliary storage device 8 also stores multiple data (for example, document data and image data) related to the above application program.

The image processor 10 outputs an image of a screen generated by the controller 4 for display on the display 12 as designated timings. Note that the display 12 is realized as a flat panel display such as an OLED display or an LCD display.

The input/output processor 14 is an interface via which the controller 4 accesses the audio processor 16 and the touch panel 20. The audio processor 16 and the touch panel 20 are connected to the input/output processor 14.

The audio processor 16 includes a sound buffer, and following instructions from the controller 4, outputs various audio data from the speaker 18.

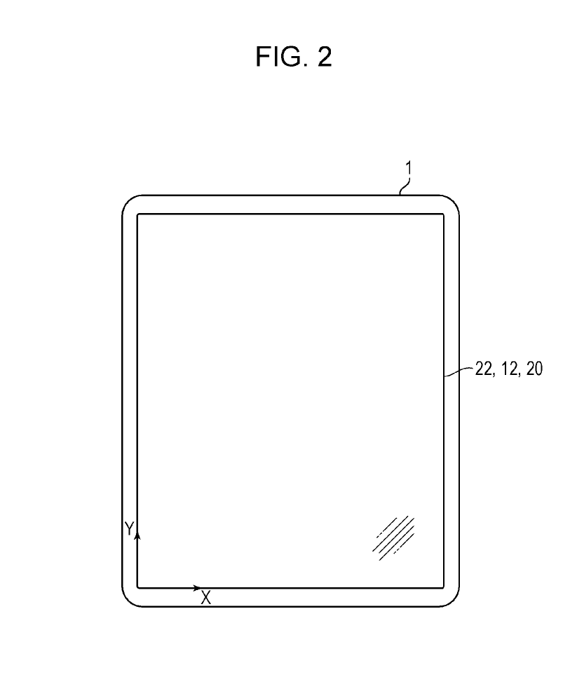

The touch panel 20 is a capacitive touch panel that detects one or multiple specified positions specified by a user's touch, and supplies the controller 4 with a detection result that includes the position coordinates of each detected specified position. The touch panel 20 is provided overlaid onto the display 12. By overlaying the touch panel 20 onto the display 12, a touchscreen 22 is formed. FIG. 2 is an exterior view of the information processing device 1. On the touchscreen 22, two coordinate axes are defined: an X axis parallel to the horizontal direction, and a Y axis parallel to the vertical direction. A specified position is expressed by a coordinate value for each coordinate axis.

Hereinafter, the positive X axis direction may be designated the rightward direction, and the negative X axis direction may be designated the leftward direction. Also, the positive Y axis direction may be designated the upward direction, and the negative Y axis direction may be designated the downward direction.

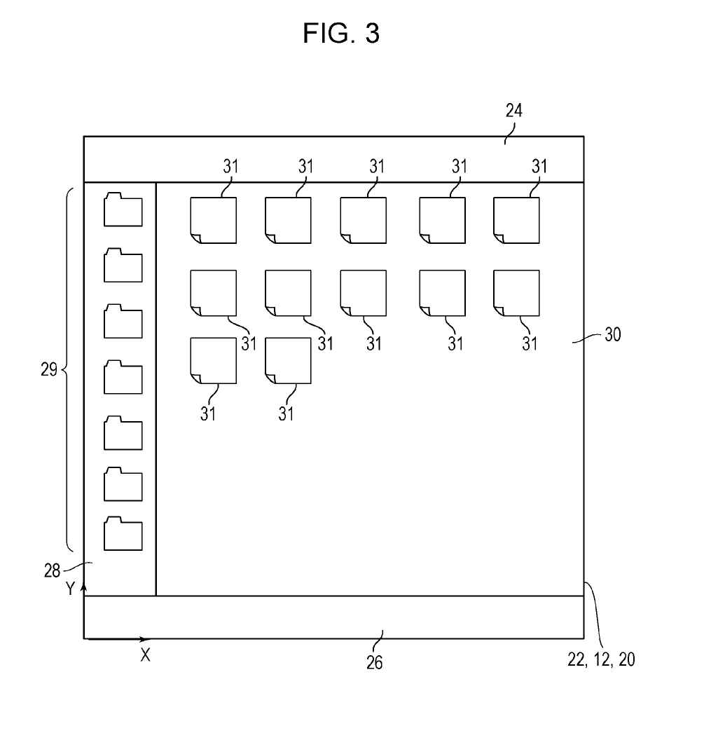

FIG. 3 is a diagram illustrating an example of a screen displayed on the touchscreen 22 by the above application program. As illustrated in FIG. 3, this screen includes a title bar area 24, a command icon area 26, a folder display area 28, and a data display area 30. The title bar area 24 is also called the header area, and the title of the screen is displayed therein. The command icon area 26 is also called the footer area, and command icon images (not illustrated) are displayed therein. Meanwhile, multiple folders 29 are displayed in a list in the folder display area 28. In addition, in the data display area 30, icon images 31 for each of multiple data are displayed in a list. In the case of the present exemplary embodiment, the icon images 31 are images of predefined size having an approximately square shape, and the positional coordinates of the upper-left vertex thereof are stored in the storage 6.

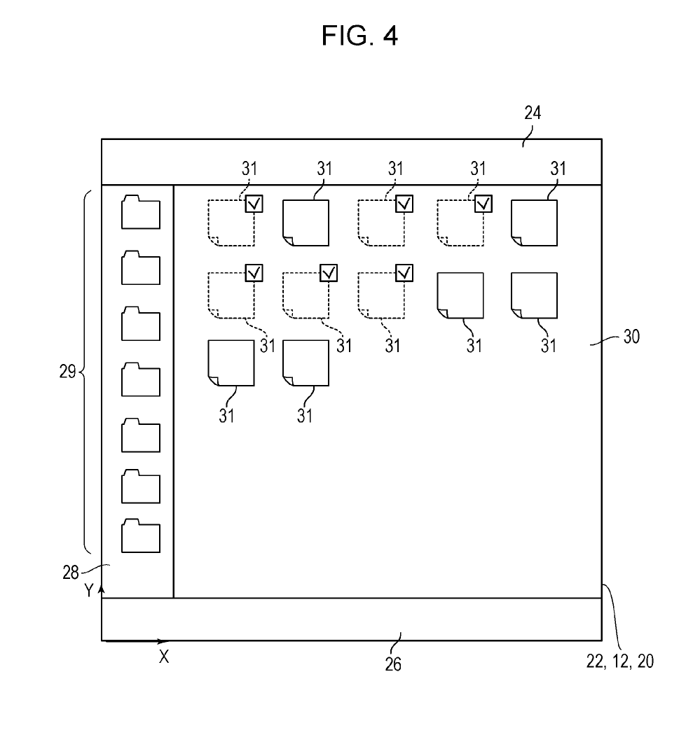

On the screen illustrated in FIG. 3, the user selects data he or she wants to drag. For example, the user selects data to drag by touching the icon image 31 for each data item to drag. After the user selects data, the relevant icon images 31 are set to semi-transparent. In addition, selection order information indicating the selection order of the selected data is generated, and stored in the storage 6. FIG. 4 is a diagram illustrating an example of a screen displayed on the touchscreen 22 when several data items are selected. The icon images 31 of data selected by the user are indicated with dashed lines. In the present exemplary embodiment, a checked checkbox is displayed near the upper-right vertex of the icon images 31 of the selected data, making it easy to ascertain which data has been selected.

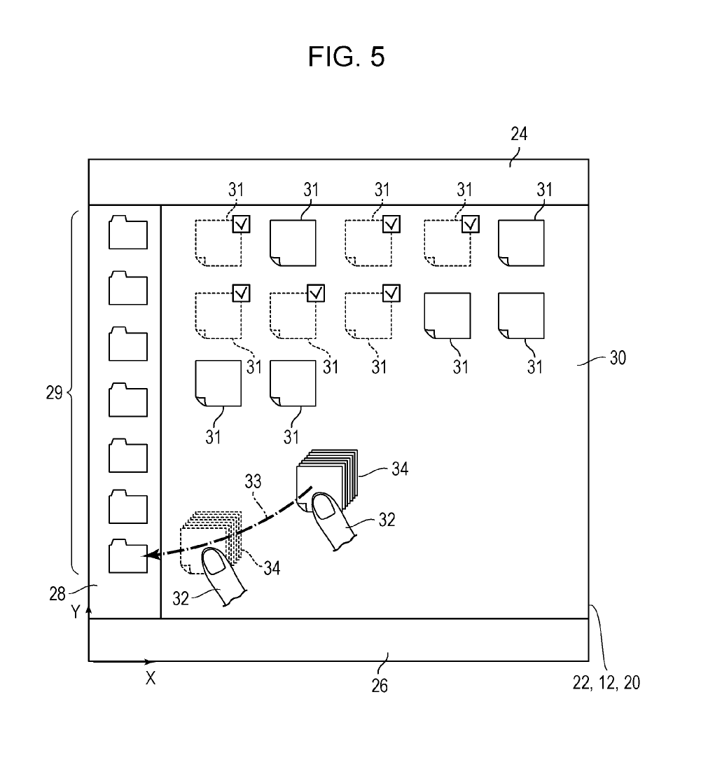

Subsequently, the user performs a drag operation, and drags the data set of the selected data. For example, the user, while maintaining contact with the touchscreen 22, moves a first finger 32 from near the icon images 31 of the selected data to a desired folder 29. In so doing, the user stores the data in the data set inside the desired folder 29. FIG. 5 is a diagram illustrating the state of the touchscreen 22 when a drag operation is performed. The arrow 33 indicates the movement path of the fingertip of the first finger 32. In the information processing device 1, while a drag operation is being performed, a bundle image 34 indicating the above data set is displayed at the specified position specified by the first finger 32. Consequently, as illustrated in FIG. 5, the bundle image 34 moves in accordance with the movement of the fingertip of the first finger 32.

Meanwhile, in some cases, the user may want to additionally store other data in the desired folder 29 while performing a drag operation.

At this point, if the user touches the icon image 31 of other data with a second finger 36 during a drag operation, the information processing device 1 adds that other data to the data set. For this reason, the user is able to add data to the data set being dragged, even while in the middle of a drag operation. In the present exemplary embodiment, if the user touches the icon image 31 of other data with the second finger 36 during a drag operation, and then moves the second finger 36 to near the bundle image 34 while maintaining contact with the touchscreen 22, that other data is added to the data set. For this reason, data may be added with an intuitive operation.

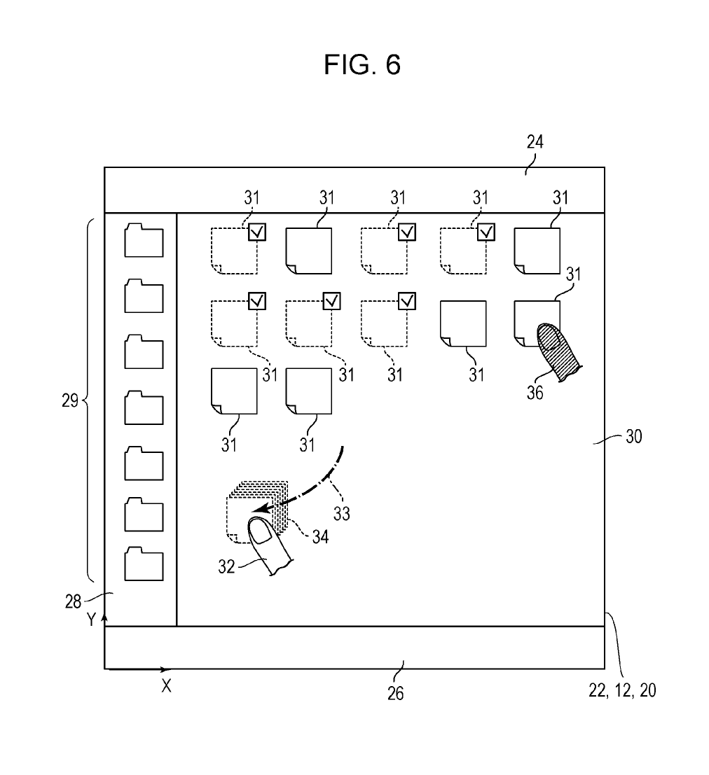

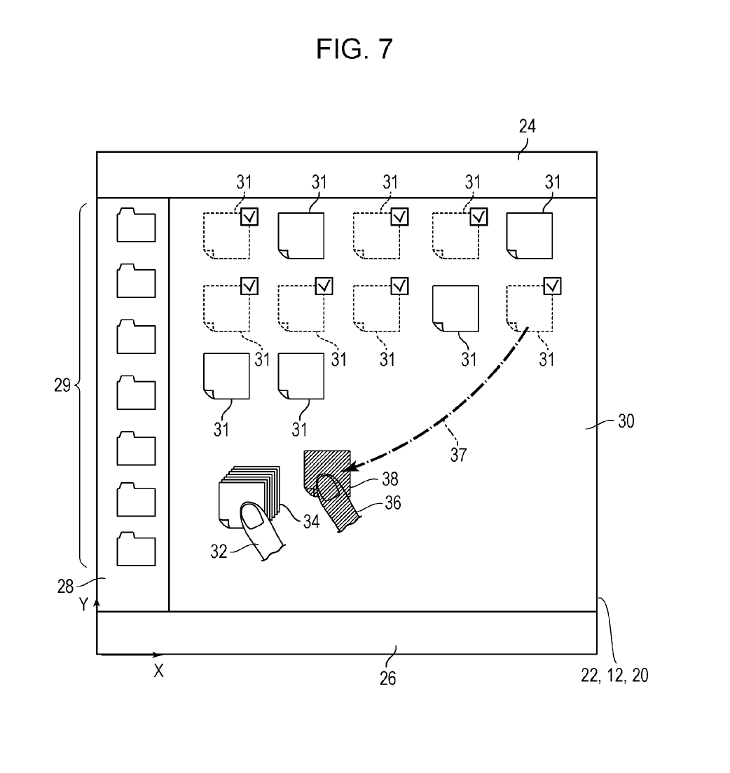

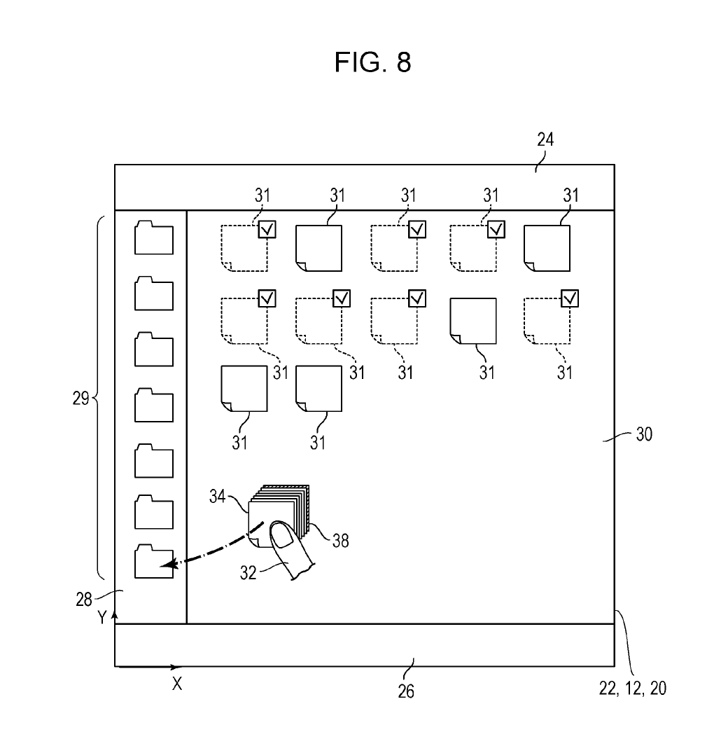

FIG. 6 is a diagram illustrating the state of a user touching an icon image 31 of other data with the second finger 36, while FIG. 7 illustrates the state of the fingertip of the second finger 36 moving after touching. FIG. 8 illustrates the state when the contact between the second finger 36 and the touchscreen 22 is disengaged near the bundle image 34. Note that the arrow 37 indicates the movement path of the fingertip of the second finger 36.

In the case of the present exemplary embodiment, if the user touches the icon image 31 of other data with the second finger 36 during a drag operation, that other data is set to a draggable state, and as illustrated in FIG. 7, a checked checkbox is displayed near the upper-right vertex of that icon image 31. Also, after that, while the second finger 36 is contacting the touchscreen 22, as illustrated in FIG. 7, a shadow image 38 of that other data is displayed at the specified position indicated by the second finger 36. For this reason, the shadow image 38 moves in accordance with the movement of the fingertip of the second finger 36. Subsequently, if the contact between the second finger 36 and the touchscreen 22 is disengaged near the bundle image 34, that other data is added to the data set. In other words, that other data is additionally selected, and as illustrated in FIG. 8, the shadow image 38 is added to the bundle image 34 as proof of the addition. As illustrated in FIG. 8, as a result of the user resuming the drag operation, the originally selected data as well as the additionally selected data is stored in a folder 29.

In addition, in some cases, the user may want to cancel a selection of data while performing a drag operation.

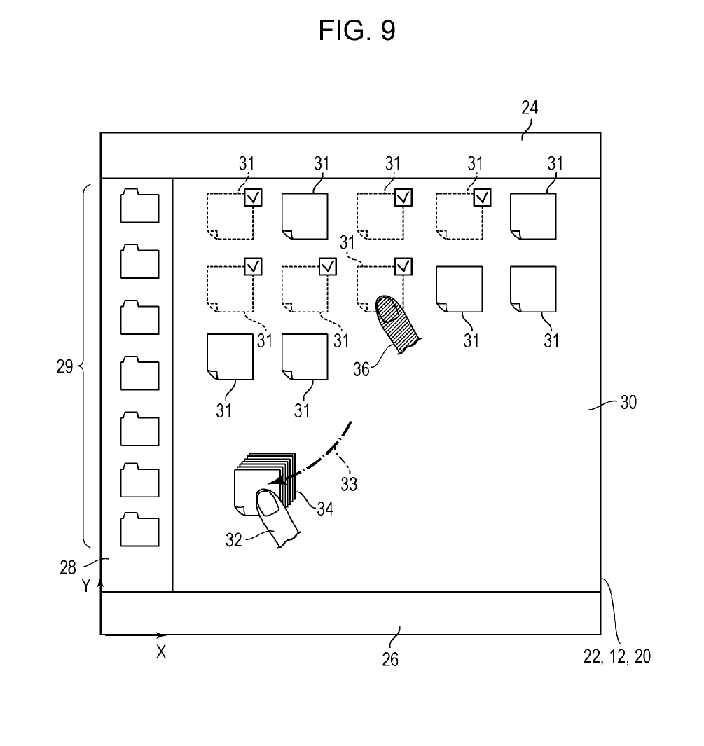

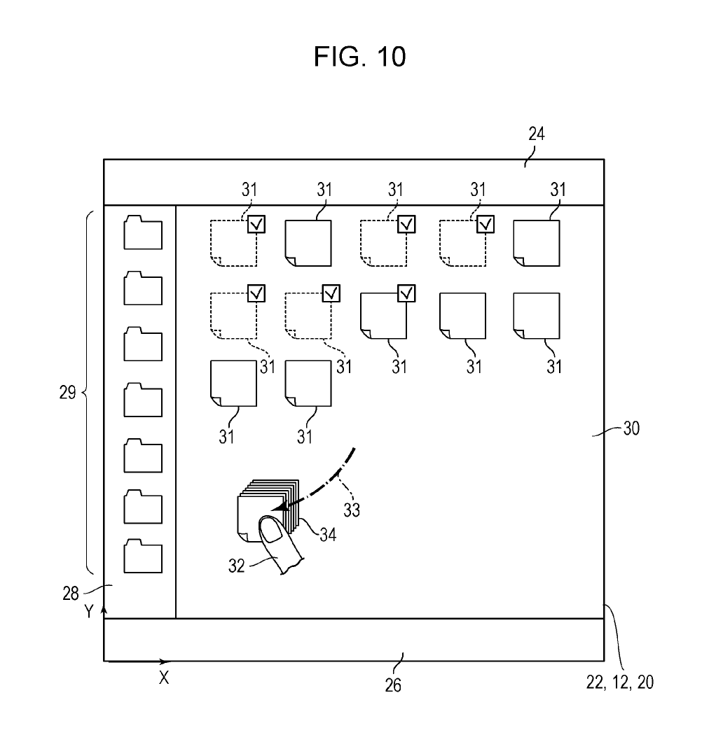

At this point, if the user touches the icon image 31 of data in the above data set with the second finger 36 during a drag operation, the information processing device 1 cancels the selection of that data. Specifically, as illustrated in FIG. 9, if the icon image 31 of data in the data set is tapped with the second finger 36 during a drag operation, the information processing device 1 removes that data from the data set. As a result, the tapped icon image 31 switches back to the original state, as illustrated in FIG. 10. For this reason, the selection of data may be cancelled, even while in the middle of a drag operation.

In addition, in some cases, the user may want to check information related to the above data set while performing a drag operation.

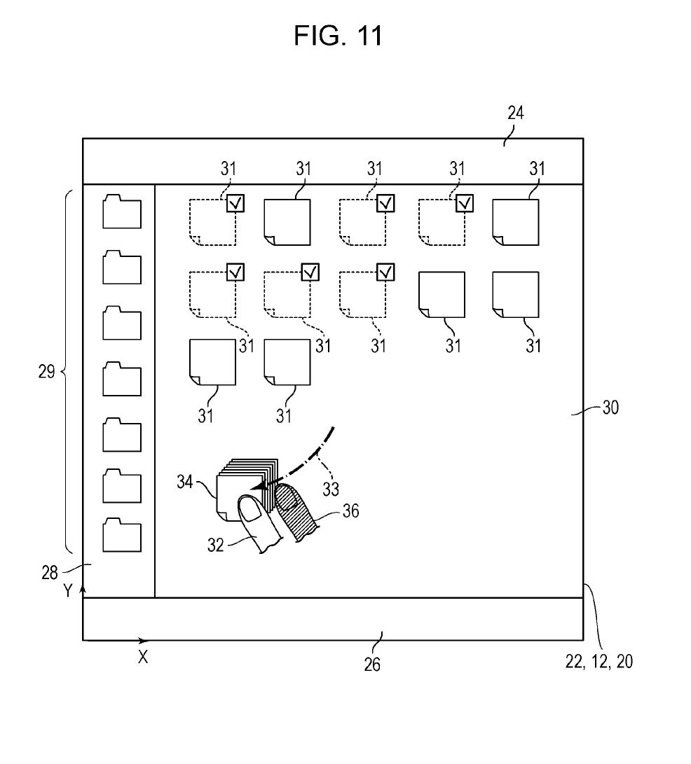

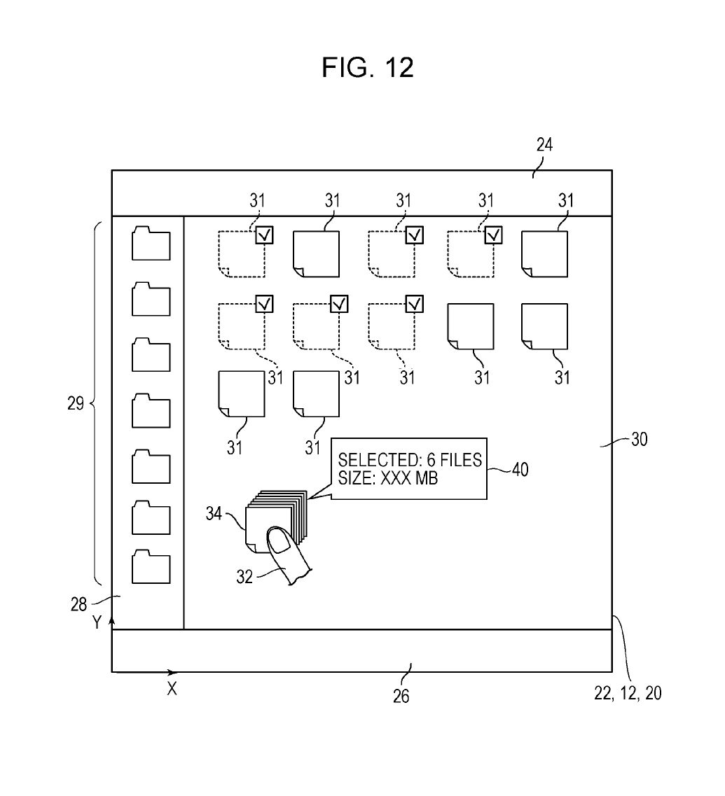

At this point, if the user touches near the bundle image 34 with the second finger 36 during a drag operation, the information processing device 1 outputs information related to the data set via an image or audio. In the present exemplary embodiment, if the user taps near the bundle image 34 with the second finger 36 during a drag operation as illustrated in FIG. 11, the information processing device 1 displays a guide image 40 indicating the number of data items belonging to the data set as well as the total data size, as illustrated in FIG. 12. For this reason, the user is able to check the number of selected data items as well as the total data size, even while in the middle of a drag operation.

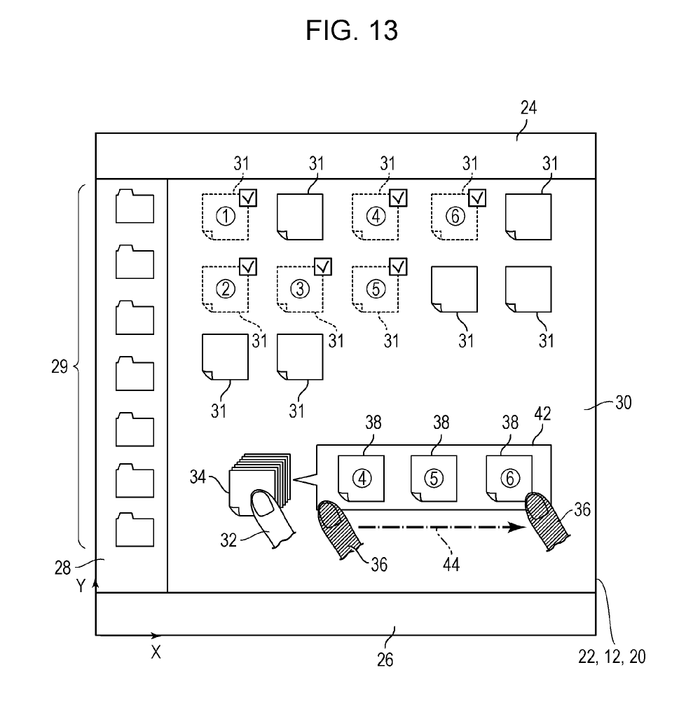

Also, in the present exemplary embodiment, as illustrated in FIG. 13, if the user touches near the bundle image 34 with the second finger 36 during a drag operation, and then performs an operation for displaying a list by dragging the second finger 36 while maintaining contact with the touchscreen 22, the information processing device 1 displays a list 42 of each shadow image 38 for some or all of the data in the data set, along the movement direction of the fingertip of the second finger 36 (hereinafter designated the flick direction). For this reason, the user is able to check which data is selected, even while in the middle of a drag operation. In addition, the display mode of the list 42 may be controlled depending on the direction in which the second finger 36 is moved.

Furthermore, in the list 42, the information processing device 1 arranges the shadow images 38 of the respective data according to the selection order of the respective data. Consequently, the user is also able to check the selection order. Note in FIG. 13, the numbers enclosed in circles indicate the selection order, and the arrow 44 indicates the flick direction.

Herein, if the flick direction is the upward direction, the information processing device 1 displays a list 42 that includes the shadow images 38 of all data in the data set, whereas if the flick direction is the leftward or rightward direction, the information processing device 1 displays a list 42 that includes the shadow images 38 of some data in the data set. Consequently, depending on the flick direction, the combination of data included in the list 42 changes. Note that if the flick direction is the leftward or rightward direction, the information processing device 1 displays a list 42 including the shadow images 38 of data from among the data in the data set whose icon image 31 is positioned on the side of the flick direction from the specified position of the first finger 32. For this reason, if the flick direction is the leftward or rightward direction, the combination of data included in the list 42 changes depending on the specified position of the first finger 32.

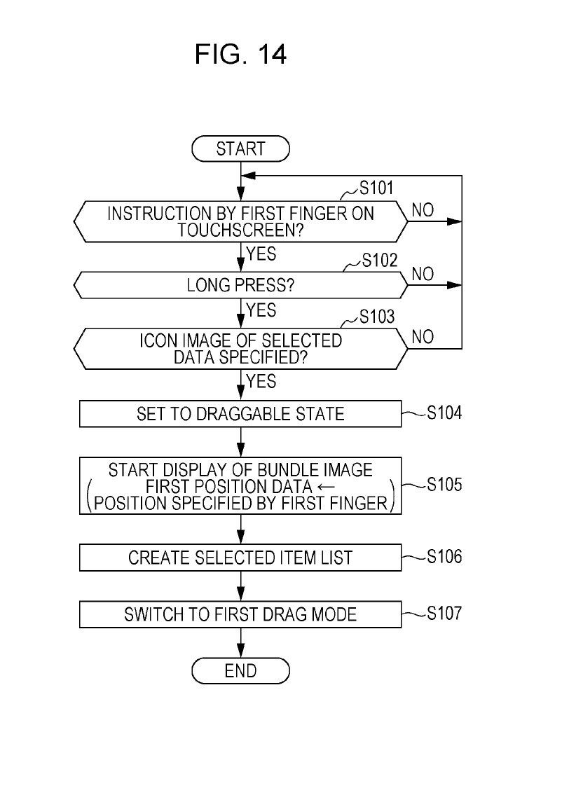

Next, a process executed in the information processing device 1 will be described. FIG. 14 is a flowchart illustrating a process that the controller 4 executes by following the above application program while in a state in which several data items are selected.

First, the controller 4 acquires a detection result from the touch panel 20, and on the basis thereof, determines whether or not the first finger 32 has specified a position on the touchscreen 22 (S101). In other words, the controller 4 determines whether or not the detection result includes only one specified position.

If the first finger 32 has specified a position on the touchscreen 22 (S101, YES), the controller 4 determines whether or not a so-called long press operation was performed, on the basis of the specified position of the first finger 32 included in the detection result (S102).

Subsequently, if a long press is performed (S102, YES), the controller 4, on the basis of the specified position of the first finger 32 included in the detection result, determines whether or not the icon image 31 of any data selected by the user is specified (S103). For example, the controller 4 determines whether or not the specified position of the first finger 32 included in the detection result is included in the display area of an icon image 31 of any data selected by the user.

If the first finger 32 has not specified a position on the touchscreen 22, and the detection result has no specified position (S101, NO), or alternatively, if the first finger 32 has specified a position on the touchscreen 22 but is not performing a long press (S102, NO), or alternatively, if a long press is being performed but an icon image 31 of data selected by the user is not specified (S103, NO), the controller 4 re-executes S101 and subsequent steps.

On the other hand, if an icon image 31 of selected data is specified (S103, YES), the controller 4 sets all selected data to a draggable state (S104), and also starts display of the bundle image 34 (S105). In the case of the present exemplary embodiment, in S105 the controller 4 sets the value of first position data stored in the storage 6 to the specified position of the first finger 32 included in the detection result, and starts displaying the bundle image 34 at the specified position expressed by the first position data. Additionally, the controller 4 generates a selected item list, and sets all selected data as the elements thereof (S106).

Subsequently, the controller 4 switches to a first drag mode (S107). Also, the user starts a drag operation. Hereinafter, the description will proceed by designating the specified position expressed by the first position data as the “first position”.

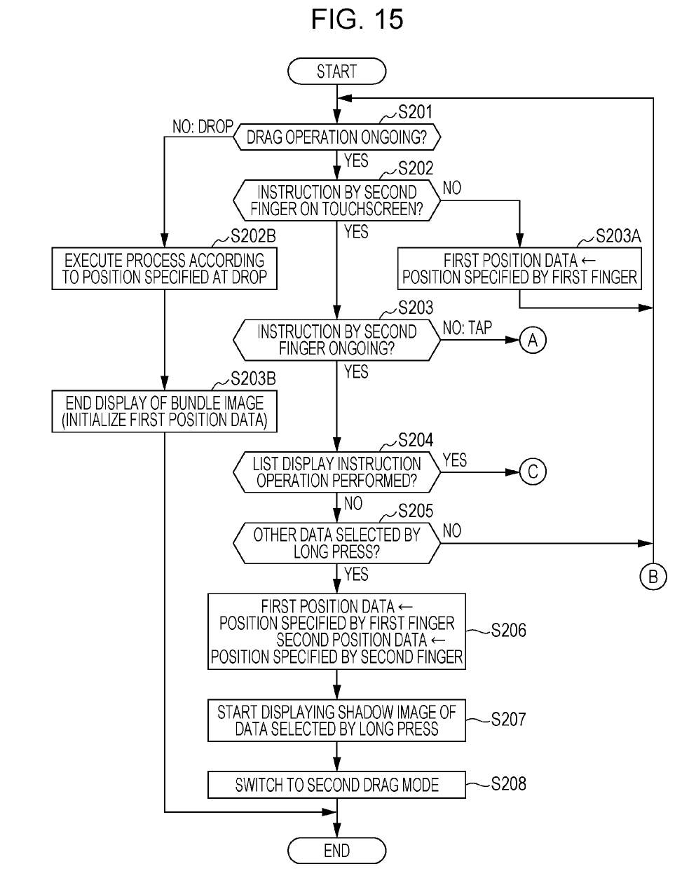

FIG. 15 is a flowchart illustrating a process that the controller 4 executes by following the above application program in the first drag mode. First, the controller 4 acquires a detection result from the touch panel 20, and on the basis of the acquired detection result, determines whether or not a drag operation is ongoing (S201). In other words, the controller 4 determines whether or not the acquired detection result includes at least one specified position.

If a drag operation is ongoing (S201, YES), the controller 4 determines whether or not the second finger 36 has specified a position on the touchscreen 22 (S202). In other words, the controller 4 determines whether or not the detection result acquired in S201 includes two specified positions. Subsequently, if the second finger 36 is not specifying a position on the touchscreen 22 (S202, NO), the value of the first position data is updated to the specified position of the first finger 32 included in the detection result acquired in S201 (S203A), and S201 and subsequent steps are re-executed.

On the other hand, if the second finger 36 has specified a position on the touchscreen 22 (S202, YES), after that, it is determined whether or not the specifying by the second finger 36 continues for some time (S203). In the case of the present exemplary embodiment, in S203 the controller 4 acquires detection results from the touch panel 20 for a fixed period, and determines whether or not all acquired detection results include two specified positions.

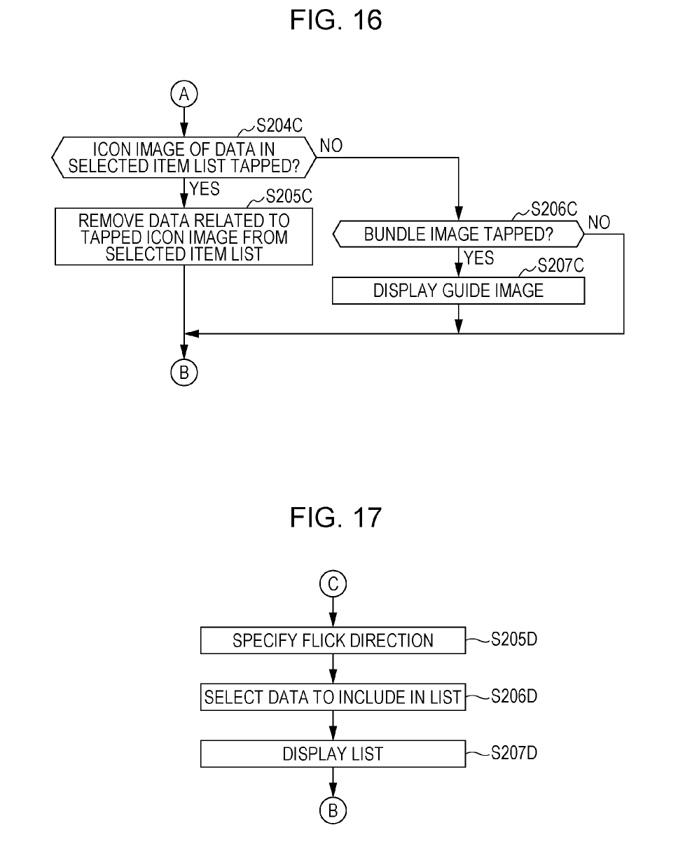

If the specifying by the second finger 36 does not continue for some time (S203, NO), the user is considered to have simply tapped the touchscreen 22 with the second finger 36. Accordingly, the controller 4 executes the process illustrated in FIG. 16. In other words, first, the controller 4 determines whether or not an icon image 31 of data in the selected item list has been tapped (S204C). In the case of the present exemplary embodiment, in S204C the controller 4 determines whether or not either of the two specified positions included in the detection result acquired in S201 is included in the display area of an icon image 31 of data in the selected item list.

Subsequently, if an icon image 31 of data in the selected item list has been tapped (S204C, YES), the controller 4 removes the data related to the tapped icon image 31 from the selected item list (S205C), and cancels the draggable state of that data. After that, S201 and subsequent steps are re-executed.

On the other hand, if an icon image 31 of data in the selected item list has not been tapped (S204C, NO), the controller 4 determines whether or not the bundle image 34 has been tapped (S206C). In the case of the present exemplary embodiment, in S206C the controller 4 determines whether or not both of the two specified positions included in the detection result acquired in S201 are included in the display area of the bundle image 34.

Subsequently, if the bundle image 34 has been tapped (S206C, YES), the controller 4 displays the guide image 40 as discussed earlier (S207C), and re-executes S201 and subsequent steps. Meanwhile, if the bundle image 34 has not been tapped (S207C, NO), the controller 4 skips the step in S207C, and re-executes S201 and subsequent steps.

Returning to the description of FIG. 15, if the specifying by the second finger 36 continues for some time (S203, YES), the controller 4 determines whether or not the operation for displaying a list discussed earlier has been performed (S204). In the case of the present exemplary embodiment, in S204 the controller 4 determines whether or not both of the two specified positions included in the detection result acquired in S201 are included in the display area of the bundle image 34.

Subsequently, if the operation for displaying a list has been performed (S204, YES), the controller 4 executes the process illustrated in FIG. 17. In other words, the controller 4 first specifies the flick direction discussed earlier (S205D). For example, in S205D, the controller 4 first detects the specified position of the second finger 36 from among the second specified positions included in the detection result acquired in S201. Also, the controller 4 detects the specified position of the second finger 36 from among the second specified positions included in the detection result acquired in S204. For example, from among the two specified positions included in the detection results, the specified position that is farther away from the first position compared to the other specified position is detected as the specified position of the second finger 36. Subsequently, the controller 4 specifies a flick direction on the basis of the specified position of the detected second finger 36.

Subsequently, on the basis of the flick direction, the controller 4 selects data to include in the list 42 from among the data included in the selected item list (S206D). In other words, if the flick direction is the upward direction, the controller 4 selects all data in the selected item list. Meanwhile, if the flick direction is the leftward or rightward direction, the controller 4 selects some data in the selected item list, on the basis of the first position. In other words, if the flick direction is the leftward or rightward direction, the controller 4 selects data from among the data in the selected item list whose icon image 31 is positioned on the side of the flick direction from the first position.

Subsequently, the controller 4 displays a list 42 extending from the first position in the flick direction (S207D). At this point, the controller 4 arranges the shadow images 38 of the respective data included in the list 42 according to the selection order of the respective data indicated by the selection order information discussed earlier. After that, the controller 4 re-executes S201 and subsequent steps.

Returning to the description of FIG. 15, if the operation for displaying a list was not performed (S204, NO), the controller 4 determines whether or not data not in the selected item list has been selected by a long press (S205). For example, the controller 4 determines whether or not one of the specified positions in the detection result acquired in S201 is included in the display area of an icon image 31 of data not in the selected item list, and also whether or not one of the specified positions in the detection result acquired in S204 is included in such a display area. If a selection by long press has not been performed (S205, NO), the controller 4 re-executes S201 and subsequent steps.

On the other hand, if a selection by long press has been performed (S205, YES), the controller 4 specifies the specified position of the first finger 32 and the specified position of the second finger 36 from among the two specified positions included in the detection result acquired in S201. In other words, from among the two specified positions, the controller 4 detects the specified position that is closer to the first position compared to the other specified position as the specified position of the first finger 32, and detects the other specified position as the specified position of the second finger 36. Subsequently, the controller 4 updates the first position data with the specified position of the detected first finger 32, and in addition, sets the value of a second position stored in the storage to the specified position of the detected second finger 36 (S206). The controller 4 then sets the data selected by long press to a draggable state, and starts displaying a shadow image 38 thereof (S207). In other words, in S207 the controller 4 causes a shadow image 38 to be displayed at the specified position expressed by the second position data.

Subsequently, the controller 4 switches to a second drag mode (S208).

Note that if the drag operation is not ongoing and a drop is performed (S201, NO), or in other words, if the detection result acquired in S201 does not include any specified position, the controller 4 executes a process depending on the specified position during the drop, that is, the first position (S202B). For example, if the first position is included in the display area of a folder 29, the user is considered to have given an instruction to store data in the folder 29. Thus, in this case, in S203B the controller 4 stores the data included in the selected item list in the folder 29. Additionally, the controller 4 stops displaying the bundle image 34, by initializing the first position data (S203B).

Hereinafter, the description will proceed by designating the specified position expressed by the second position data as the “second position”.

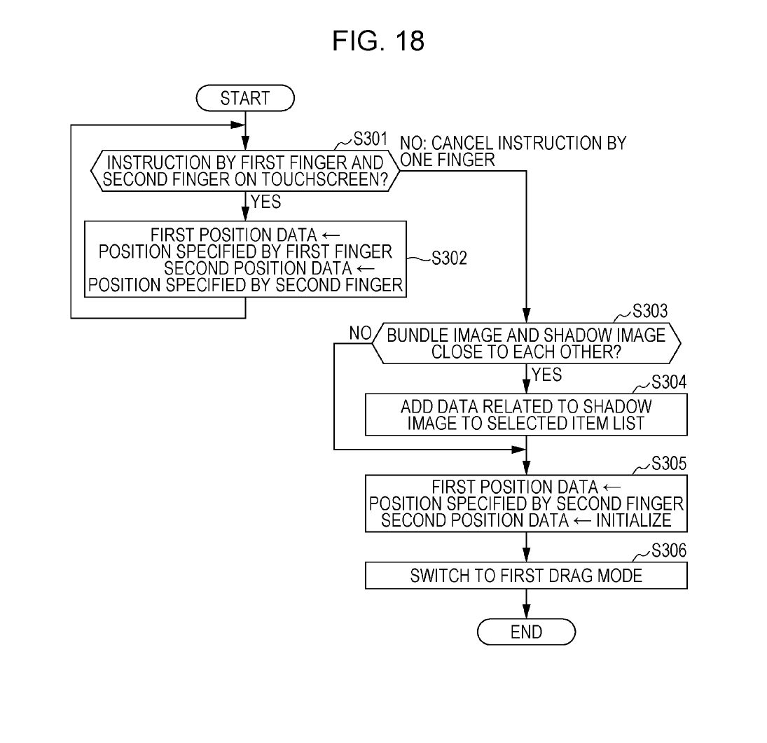

FIG. 18 is a flowchart illustrating a process that the controller 4 executes by following the above application program in the second drag mode. First, the controller 4 acquires a detection result from the touch panel 20, and on the basis of the acquired detection result, determines whether or not the first finger 32 and the second finger 36 have specified positions on the touchscreen 22 (S301). In other words, the controller 4 determines whether or not the acquired detection result includes two specified positions.

If the first finger 32 and the second finger 36 have specified positions on the touchscreen 22 (S301, YES), the controller 4 detects the specified position of the first finger 32 and the specified position of the second finger 36 on the basis of the first position. In other words, from among the two specified positions included in the acquired detection result, the controller 4 detects the specified position that is closer to the first position compared to the other specified position as the specified position of the first finger 32, and detects the other specified position as the specified position of the second finger 36. Subsequently, the controller 4 updates the first position data with the specified position of the detected first finger 32, and updates the second position data with the specified position of the detected second finger 36 (S302). In this way, the controller 4 moves the shadow image 38 according to the movement of the fingertip of the second finger 36.

On the other hand, if the detection result acquired in S301 includes only one specified position, or in other words if the specifying by one of the fingers is cancelled (S301, NO), the controller 4 determines whether or not the bundle image 34 and the shadow image 38 are close to each other (S303). In the present exemplary embodiment, the controller 4 determines whether or not the distance between the first position and the second position is a designated distance or less. By executing step S303, the controller 4 determines whether or not the specifying by one of the fingers has been cancelled when the specified position of the first finger 32 and the specified position of the second finger 36 are close to each other.

If the bundle image 34 and the shadow image 38 are close to each other (S303, YES), the controller 4 adds the data related to the shadow image 38 to the selected item list (S304). As a result, the data related to the shadow image 38 is additionally selected.

Subsequently, the controller 4 initializes the second position data, and stops displaying the shadow image 38. Also, the controller 4 updates the value of the first position data to the specified position included in the detection result acquired in S301 (S305). Subsequently, the controller 4 switches to the first drag mode (see FIG. 15) (S306).

Note that if the bundle image 34 and the shadow image 38 are not close to each other (S303, NO), the draggable state of the data related to the shadow image 38 is cancelled, and S305 and subsequent steps are executed.

Note that an exemplary embodiment of the present invention is not limited to just the exemplary embodiment discussed above.

For example, in S302, the controller 4 may detect the specified position of each of the first finger 32 and the second finger 36, on the basis of the second position rather than the first position. In this case, from among the two specified positions included in the detection result acquired in S301, the controller 4 may detect the specified position that is farther away from the second position compared to the other specified position as the specified position of the first finger 32, and detect the other specified position as the specified position of the second finger 36. Note that if the distance from the second position is the same for both specified positions included in the detection result, next, the distance from the first position may be computed for each of the specified positions, and on the basis of the computed distances, the specified position for each of the first finger 32 and the second finger 36 may be detected.

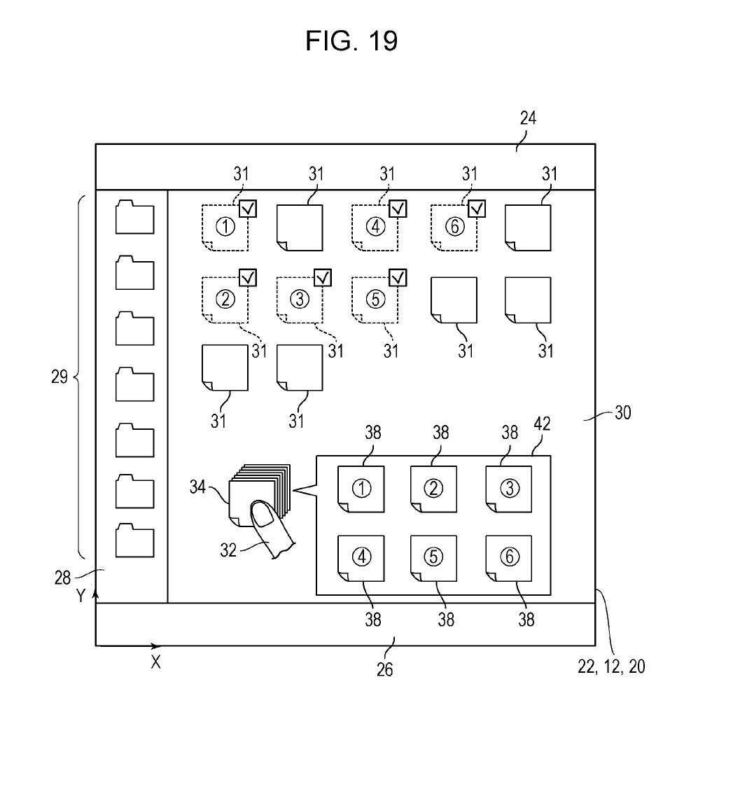

As another example, if the bundle image 34 is tapped in the middle of a drag operation (S206C in FIG. 16), the controller 4 may display a list 42 including the shadow images 38 of all data in the selected item list, instead of displaying the guide image 40. FIG. 19 illustrates an example of the list 42. As illustrated in FIG. 19, in this case, the shadow images 38 of the respective included in the list 42 are likewise arranged according to the selection order of the respective data. Note that this list 42 may also be displayed if the bundle image 34 is double-tapped in the middle of a drag operation.

As another example, if a shadow image 38 included in the list 42 is tapped in the middle of a drag operation, the controller 4 may remove the data related to the tapped shadow image 38 from the selected item list. In this case, in S204C of FIG. 16, for example, the controller 4 may be configured to determine whether or not either of the two specified positions included in the detection result acquired in S201 is included in the display area of an icon image 31 of data in the selected item list, or a shadow image 38 in the list 42. Subsequently, if the specified position of the second finger 36 is included in the display area of a shadow image 38 in the list 42, the controller 4 may remove the data related to that shadow image 38 from the selected item list in S205C. Also, if a path starting from a shadow image 38 included in the list 42 and leading outside the list 42 is input in the middle of a drag operation, the controller 4 may remove the data related to that shadow image 38 from the selected item list.

Additionally, although the list 42 is displayed along the flick direction in the above exemplary embodiment, this is merely one example, and the display mode of the list 42 may be varied in any way according to the flick direction. Also, the combination of data included in the list 42 may also be varied in any way according to the flick direction.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a position acquisition unit that acquires a first position and a second position specified on an image of a screen by a user; and
an adding unit configured so that, in a case in which the user is in the middle of continuously specifying the first position for a set of a plurality of data selected by the user, and a position associated with other data besides the data set is acquired as a second position, the adding unit adds the other data to the data set.

2. The information processing device according to claim 1, wherein
in a case in which, after a position associated with the other data is acquired as the second position while a user is in the middle of continuously specifying the first position for a set of a plurality of data selected by the user, a first position and a second position are close to each other, and the specifying of one of the first position and the second position is cancelled, the adding unit adds the other data to the data set.

3. The information processing device according to claim 1, further comprising:
a related information output unit configured so that, in a case in which a user is in the middle of continuously specifying the first position for a set of a plurality of data selected by the user, and a position associated with the first position is acquired as a second position, the related information output unit outputs information related to the data set.

4. The information processing device according to claim 3, wherein
the related information output unit is configured so that, in a case in which a user is in the middle of continuously specifying the first position for a set of a plurality of data selected by the user, and a position associated with the first position is acquired as a second position, the related information output unit displays a list of all or some of the data in the data set.

5. The information processing device according to claim 4, wherein
the related information output unit displays the list by arranging all or some of the data in an order according to a selection order.

6. The information processing device according to claim 4, wherein
the related information output unit varies a display mode of the list according to a second position acquired after a position associated with a first position is acquired as a second position.

7. The information processing device according to claim 6, wherein
the related information output unit varies a combination of data included in the list according to a second position acquired after a position associated with a first position is acquired as a second position.

8. The information processing device according to claim 7, wherein
the related information output unit varies a combination of data included in the list according to a first position, and a second position acquired after a position associated with a first position is acquired as a second position.

9. An information processing method comprising:
acquiring a first position and a second position specified on an image of a screen by a user; and
adding so that, in a case in which the user is in the middle of continuously specifying the first position for a set of a plurality of data selected by the user, and a position associated with other data besides the data set is acquired as a second position, the other data is added to the data set.

10. A non-transitory computer readable medium storing a program causing a computer to execute a process for processing information, the process comprising:
acquiring a first position and a second position specified on an image of a screen by a user; and
adding so that, in a case in which the user is in the middle of continuously specifying the first position for a set of a plurality of data selected by the user, and a position associated with other data besides the data set is acquired as a second position, the other data is added to the data set.
